(19) United States
(12) Patent Application Publication
(10) Pub. No.: US 2004/0094622 A1
(43) Pub. Date: May 20, 2004

(54) Apparatus and method for evaluating a charge for the use of a vehicle

(76) Inventor: Walter Vismara, Milano (IT)

Correspondence Address: LADAS & PARRY, 224 SOUTH MICHIGAN AVENUE, SUITE 1200, CHICAGO, IL, 60604, US

(21) Appl. No.: 10/381,349

(22) PCT Filed: Jun. 13, 2001
(86) PCT No.: PCT/IT01/00301

(51) Int. Cl. G07B 15/02

(52) U.S. Cl. 235/384

(57) ABSTRACT

The present invention relates to apparatus and to a method for evaluating a charge for the use of a vehicle or craft on hire, comprising at least one locating device which makes available data relating to the current position of the vehicle or craft, a timing device which makes available data relating to the period of use of the vehicle or craft, and a data-processor which is connected at least to the locating device and to the timing device and which acquires the data relating to the current position and the data relating to the period of use in order to calculate the charge for the use of the vehicle or craft on the basis at least of these data.

### FIELD OF THE INVENTION

The present invention relates to apparatus and to a method for evaluating a charge for the use of a vehicle or craft, according to the preambles to claim 1 and to claim 29, respectively.

### BACKGROUND OF THE INVENTION

As is known, the charge for the use of a vehicle or craft means the rental paid by the user or hirer of the property to the owner or provider of the property in order to obtain availability of the property for a predetermined period of time. The contract entered into in accordance with the conditions described is known as a hire or charter agreement and corresponds substantially to the hiring of the property for a period of time of medium or long duration.

In the field of hire or charter agreements for property with high technological content and, in particular, of vehicles or craft, there is an ever greater and unsatisfied need to offer to the user of the vehicle or craft the opportunity to pay to the provider a hire charge the amount of which is determined on the basis of the actual way in which the hired vehicle or craft is used, of the reliability of the user, of the areas in which the vehicle or craft is actually used, and the like.

However, the solutions currently used to evaluate the hire charge take into consideration the value of the property in question, the duration of the period of use of the vehicle or craft, which is indicated by the user, and the predictable costs of maintenance services to be performed during the period. The charge is evaluated on the basis of these parameters at the time when the hire or charter agreement is entered into and remains the same throughout the period of use of the vehicle or craft.

Clearly, in this case, there is no relationship between the charge paid by the user and the way in which the vehicle or craft is actually used. In fact, for various reasons, the vehicle or craft hired may not actually have been used during the period of availability but, in the case of a motor-vehicle, may have been kept in a car park, or in the case of a boat, in harbour. Conversely, it may have been used in busy areas or in areas which are notoriously dangerous for traffic or navigation, or the vehicle or craft may be used in other situations of risk.

### SUMMARY OF THE INVENTION

The problem underlying the present invention is that of devising apparatus, as well as a method, for evaluating the charge for the use of a vehicle or craft, particularly, of cars, motorcycles and boats, which have functional characteristics and procedural steps such as to respond to the above-mentioned needs and at the same time to avoid the problems discussed with reference to the prior art.

This problem is solved by apparatus according to claim 1 which can evaluate a charge for the use of a vehicle or craft, as well as by the method according to claim 29.

### BRIEF DESCRIPTION OF THE DRAWINGS

Further characteristics and the advantages of the apparatus according to the present invention will become clear from the following description of a preferred embodiment thereof, given by way of non-limiting example, with reference to the appended drawings, in which:

FIG. 1 is a general view of a preferred embodiment of the apparatus and of a vehicle or craft represented, by way of example, by a boat,

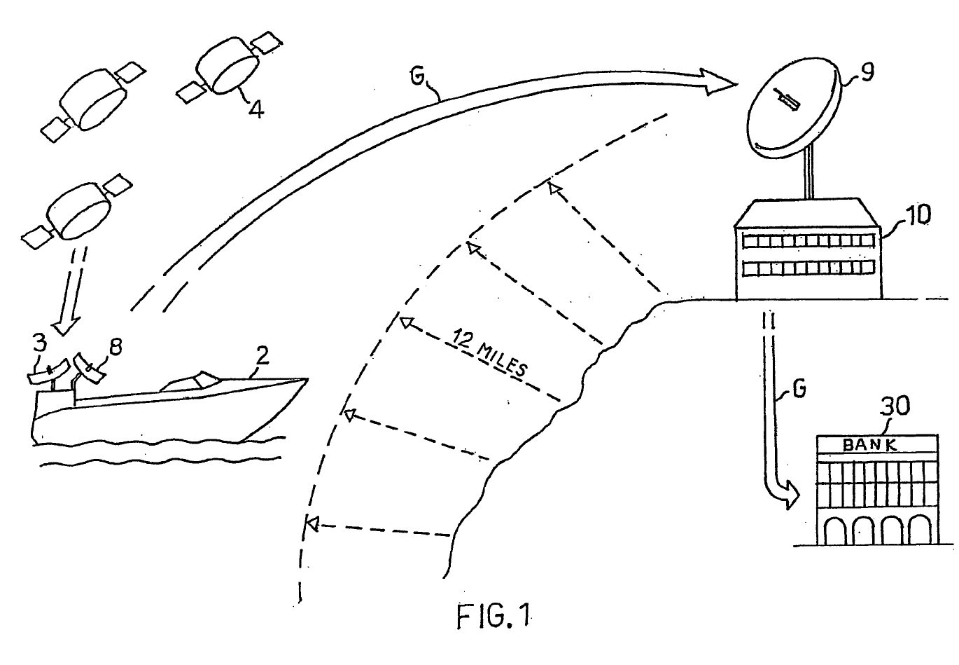

FIG. 2 is a block diagram of the devices and means which make up the apparatus, and of the data-flow between the devices and means,

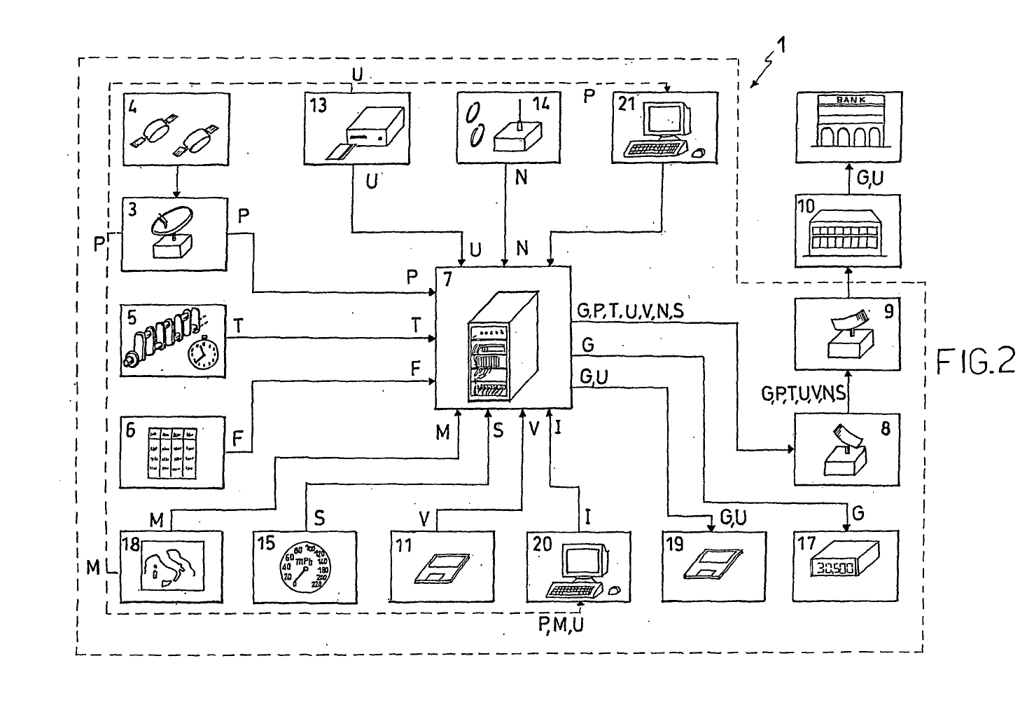

FIG. 3 is a flow chart which illustrates the method used by the apparatus to evaluate the charge for the use of the vehicle or craft, and

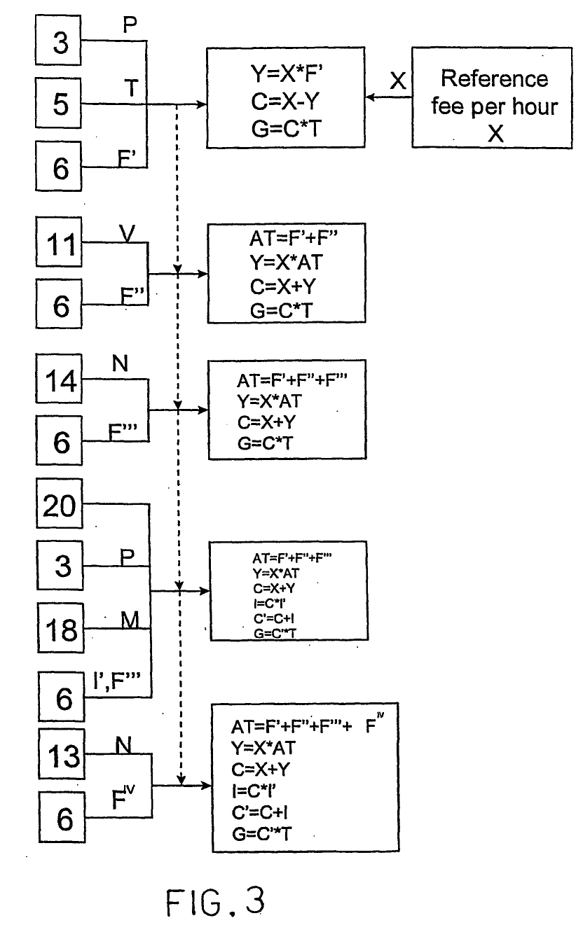

FIG. 4 is a table which contains a tariff, in a particular embodiment of the apparatus.

### DETAILED DESCRIPTION OF THE PREFERRED EMBODIMENTS

With reference to the appended drawings, apparatus according to the invention for evaluating a charge for the use of a vehicle or craft, in the specific embodiment, a boat 2, is generally indicated 1 and can evaluate the charge in relation at least to the current location of the boat and to the period of use in the same conditions, on the basis of a flexible tariff set by the provider.

The apparatus 1 comprises a locating device 3 which can determine and continuously make available over time data relating to the current position P of the craft 2.

By way of example, the locating device 3 comprises a conventional global positioning system (GPS) or Standard C system which, when operatively associated with a satellite system 4, can determine the precise location of the craft by methods known in the specific field.

The apparatus 1 also comprises a timing device 5 installed on board the craft 2 for determining and making available data relating to the period of use T of the craft 2. The timing device 5 comprises an activation sensor which can evaluate the condition of use of the craft, that is, whether it is moving or stationary, or is not in use, and a timer.

By way of example, the activation sensor is a position transducer associated with a transmission member of the craft. As is known, the position transducer can detect the movement of the transmission member of the craft and can send a suitable start/stop signal to the timer. The position transducer and the timer, operating jointly, can advantageously detect the duration of the moving or stationary condition of use of the craft, as well as of the condition in which the craft is not in use.

The apparatus 1 also comprises a tariff-fixing device 6 for making available data relating to rates F predefined by the provider on the basis of a tariff.

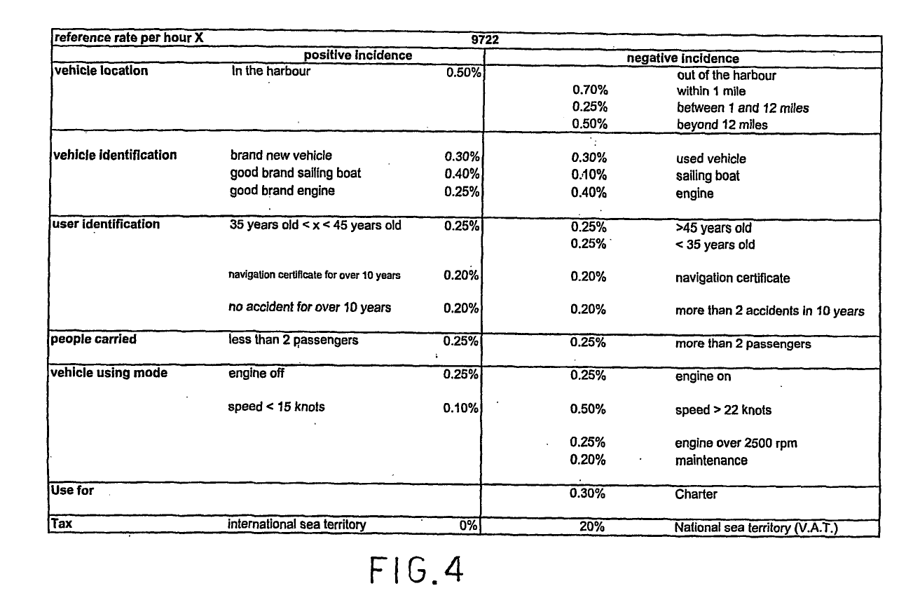

By way of example, the tariff-fixing device 6 comprises a table of the type shown in FIG. 4. The table contains the entire tariff provided for by the provider. In other words, the table contains the rates to be applied in order to determine the charge G for the use of the craft, each rate being applicable in a predetermined condition of use of the craft, which is determined on the basis of the data collected by the devices included in the apparatus 1, such as the location of the craft, and the like.

The apparatus 1 also comprises a data-processor 7, provided on board the craft 2 and operatively connected at least to the locating device 3, to the timing device 5, and to the tariff-fixing device 6. The data-processor 7 can evaluate the charge G for the use of the craft, at least on the basis of the data P relating to the current position of the craft, of data T relating to the period of use, and of the tariff data F.

The apparatus 1 also has a device 18 for controlling maps or charts, which device can store maps or charts and make available data M relating thereto. Advantageously, the map or chart control device 18 is operatively connected at least to the data-processor 7.

In a preferred embodiment of the apparatus 1, the map or chart control device 18 comprises optical or magnetic substrates such as a CD-ROM, a floppy disk, or the like, operatively associated with the respective optical or magnetic readers.

The locating device 3, the timing device 5, the tariff-fixing device 6, and the map or chart control device 18, operating jointly with the data-processor 7, can determine a charge G for the use of the craft 2.

The data-processor 7 in fact acquires the data P relating to the current position of the craft 2 from the locating device 3 and, by means of the connection with the chart control device 18, applies an hourly rate which varies on the basis of the location of the craft 2, for example, within 12 miles or beyond 12 miles from the coast. Various variation factors to be applied to a reference hourly rate X in the situation described by way of example, are made available to the data-processor 7 by the tariff-fixing device 6, and the location of the craft 2 is worked out by the data-processor 7 by means of a comparison of the data P relating to the current position with the chart data M.

By way of example, for the use of a boat, the hourly rates to be applied for a craft which is moored in a harbour or is outside the harbour may differ, since the presence of the boat in the harbour indicates a period in which navigation is suspended by the user and in which the use of the craft can therefore be evaluated differently.

According to a further example, for the use of a car, the hourly rates connected with the location of the vehicle may differ on the basis of whether the vehicle is used within or outside urban centres.

According to one particular embodiment, the apparatus 1 comprises means 11 for identifying the vehicle or craft, the means 11 being provided in the vehicle or craft 2, operatively connected to the data-processor 7, and capable of providing the data-processor 7 with data V relating to the vehicle or craft used. The data V relating to the vehicle or craft used enables the charge G to be evaluated on the basis of the vehicle or craft 2 used. In fact, the hourly rates to be applied for the use of a new or expensive vehicle or craft may advantageously be higher than those applicable for a vehicle or craft which is used or of low market value.

In a preferred embodiment, the means 11 for identifying the vehicle or craft comprise a device for storing data V relating to the vehicle or craft used, by way of example, the vehicle registration number, on a magnetic or optical substrate, and respective magnetic or optical readers.

The apparatus 1 also comprises means 13 for identifying the user, the means being provided on board the vehicle or craft, operatively connected to the data-processor 7, and capable of making available to the data-processor 7 data U relating to the user's identity, in order for the charge G for the use of the vehicle or craft to be evaluated on the basis of the user's identity U.

According to one embodiment, the user-identification means 13 can cooperate with a card provided with an integrated circuit (a smart card) on which the data relating to the user's identity U are stored, and also comprise a smart-card reader.

In another embodiment, the user-identification means 13 comprise a keyboard on which the user keys in his identity data U such as, for example, his tax reference, the PIN number of a credit card, a VAT entry, or a password assigned by the provider, his occupation, or the like.

Advantageously the user-identification means 13, the data-processor 7, and the tariff-fixing device 6, operating jointly, can determine a charge G for the use of the vehicle or craft 2 on the basis of different hourly rates set by the provider and also taking account, by way of example, of the overall hire hours accumulated by a user.

Moreover, the apparatus 1 has means 14, operatively associated with the data-processor 7, for detecting the number of individuals on board the vehicle or craft, and for making available to the data-processor 7 data relating to the number N of individuals on board in order for the charge G for the use of vehicle or craft to be determined on the basis of the data relating to the number N of people on board.

In a preferred embodiment of the apparatus 1, the means 14 for detecting the number of individuals on board the vehicle or craft comprise conventional bracelet-transponder systems. Bracelet transponder systems can detect the presence of individuals wearing bracelets within an area, in accordance with known methods. Moreover, in the embodiment of the apparatus 1 for evaluating the charge G for the use of a boat, bracelet transponder systems can advantageously detect the presence of one or more individuals outside the perimeter of the boat, transmitting an activation signal to acoustic and visual danger warning devices.

In a further preferred embodiment, the means 14 for detecting the number of individuals on board the vehicle or craft comprise a keyboard on which the user keys in the number of individuals on board.

A further advantage due to the presence, in the apparatus 1, of the means 14 for detecting the number of individuals on board, is that the provider can provide insurance cover which takes account of the actual number of individuals on board and/or can issue to each individual a separate invoice for the amount of the hire charge G due.

In a preferred embodiment, the apparatus 1 comprises means for detecting the current speed 15 of the vehicle or craft 2, and for making available data S relating to the current speed of the vehicle or craft, and/or means for detecting acceleration. By way of example, the means 15 for detecting the speed of the vehicle or craft 2 comprises a tachometer in the case of a car or a motorcycle, or a log, that is, a device for measuring the speed of a vessel, in the case of a boat.

Furthermore, the apparatus 1 comprises devices 12 for evaluating risks such as the risk connected with driving or navigating in busy areas, and the like, the devices 12 being operatively connected to the data-processor 7, to the device 3 for locating the vehicle or craft, to the timing device 5, and to the map or chart control device 18, and being capable of providing the data-processor 7 with data relating to the presence of the risk.

In a preferred embodiment of the invention, the risk-evaluating devices 21 comprise a computer and are also connected at least to one of the means 11 for identifying the vehicle or craft, the user-identification means 13, the means 14 for detecting the number of individuals, the means 15 for detecting the speed of the vehicle or craft, and/or the means for detecting the acceleration of the vehicle or craft.

Advantageously, the device 21 for determining a risk, such as the risk resulting from the use of the vehicle or craft by an inexperienced user, the use of the vehicle or craft at high speed or with abrupt manoeuvres, the presence of a large number of individuals on board, and the like, can determine the charge G for the use of the vehicle or craft 2, in cooperation with the data-processor 7, the tariff-fixing device 6, and the map or chart control device 18, on the basis of the risk connected with the way in which the vehicle or craft is used, of the areas in which driving or navigation took place, of the reliability of the user, and the like.

By way of example, the risk-determining devices 21 and the locating device 3, in cooperation with the data-processor 7 and the tariff-fixing device 6, enable the charge G to be determined on the basis of the location of the vehicle or craft. For the use of a boat, for example, it is possible to apply higher rates if navigation takes place beyond a predetermined distance from the coast or in areas considered dangerous to traffic or for navigation.

Similarly, again by way of example, it is possible, in determining the charge for the use of the vehicle or craft, to take into consideration the ways in which the vehicle or craft is used, applying higher hourly rates if the use takes place at high speeds or with rapid acceleration. It is also possible to take into consideration the type of user, applying cheaper rates for a user older than a predetermined age, or who has been possession of a licence to drive the vehicle or of a navigation certificate for a long time.

In a preferred embodiment, the apparatus 1 also has tax-evaluation means 20, preferably a computer, operatively connected at least to the device 3 for locating the vehicle or craft, to the map or chart control device 18 and to the data-processor 7. The tax-evaluation means 20 can make available to the data-processor 7 a tax amount I.

By way of example, for the use of a boat, with the use of the tax-evaluation means 20, cooperating with the locating device 3 and the map or chart control device 18, it is possible to determine the charge G for the use of the boat, taking account of the application of any value-added tax (VAT), which does not have to be debited if navigation takes place in international waters.

In a further preferred embodiment, the tax-evaluation means 20 are operatively connected to the locating device 3, to the map or chart control device 18, to the device 11 for identifying the vehicle or craft, and to the user-identification device 13. In a preferred embodiment, in which the tax-evaluation means 20 are also operatively connected to the device 11 for identifying the vehicle or craft, it is advantageously possible to evaluate the tax on the basis of the type of vehicle or craft used, for example, an electric vehicle or the like.

According to yet a further embodiment, the charge G for the use of the vehicle or craft, determined in suitable manner by the data-processor 7, is sent, by means of a data-transmission device 8 provided on board the vehicle or craft 2, to a data-receiving device 9 provided in a processing centre 10. The data-transmission device 8 can also transmit to the processing centre 10 data relating to the current position P of the vehicle or craft, to the period of use T, to the vehicle or craft V used, to the user's identity U, to the number N of individuals on board the vehicle or craft, to the current speed S of the vehicle or craft, and to the current acceleration.

The data-transmission device 8 advantageously comprises radio-wave transmission means, for example, a conventional GSM system. In one embodiment of the device, the GSM system, operatively connected to the data-processor 7, is used to transmit from the vehicle or craft 2 to the processing centre 10, the charge G for the use of the vehicle or craft, and the data relating to the user's identity U, in order to identify the user of the vehicle or craft.

The apparatus 1 is also provided with a device 19, operatively connected to the data-processor 7, for storing the charge G for the use of the vehicle or craft.

In a preferred embodiment of the invention, the apparatus 1 also comprises means for crediting/debiting the charge G for the use of the vehicle or craft to a credit institution indicated by the hirer such as, for example, a bank, a credit-card loop, or the like.

The apparatus 1 also has a visual indicator 17, typically a display, disposed on the vehicle or craft, connected to the data-processor 7, and capable of displaying the charge G for the use of the vehicle or craft.

The principal steps of the operation of the above-described apparatus 1 for evaluating a charge G in some conditions of use of the vehicle or craft, in this case, a boat, are described by way of example below.

The boat 2, provided with the apparatus 1, is chartered by a user, by entering into a contract with the provider, who sets a reference hourly rate X which the user will have to pay to the provider for the entire duration of the period of use of the boat 2, and which may or may not be increased by taxes.

The reference hourly rate X is subject to increases or to reductions on the basis of the evaluations performed by the apparatus 1 during the period of use of the property.

Reference will be made below to an example in which, during a first period of use of a few days' duration, the boat subject to the charter agreement is kept in a harbour with the engine switched off, and with a number of individuals greater than two accommodated on board.

The locating device 3 disposed on board the craft continuously determines the position P occupied by the boat, by means of a conventional GPS system, and makes the data relating to the current position P available to the data-processor 7. The activation sensor and the timer of the timer device 5, operating jointly, can evaluate the period of use T of the boat in these conditions, expressed in hours. For the above-mentioned conditions, that is, for a boat which is stationary in harbour, the tariff-fixing device 6, such as a table, contains and makes available to the data-processor 7 a variation factor F′ to be applied to the reference hourly rate X due to the stay in harbour.

The device 7 calculates a variation Y of the reference hourly rate X by multiplying the reference hourly rate X by the variation factor F′ due to the location of the boat in harbour, adds/subtracts the variation Y to/from the hourly rate X, calculating an hourly rental C, and calculates the charge G for the use of the craft by multiplying the hourly rental C by the period of use T in these conditions, expressed in hours.

The charge G calculated by the data-processor 7 is transmitted to the processing centre 10 by the data-transmission device operatively connected to the data-processor 7, is received by the data-receiving device 9, and is stored by the device 19 for storing the charge G. A credit/debit loop can acquire the charge G in known manner and credit/debit it to the current account indicated by the user.

The vehicle-identification means 11, for example, storage devices, advantageously make data relating to the vehicle V used available to the data-processor 7. In the example described, the boat is a motor boat of known brand. The data-processor 7 can also acquire from the tariff-fixing device 6 a variation factor F″ for the use of a motor boat of known brand.

The data-processor 7 calculates a variation Y of the rate X by multiplying the reference hourly rate X by the total factor AT which is the algebraic sum of the factor F′ due to the stay in harbour and of the factor F″ due to the use of a motor boat of known brand, adds/subtracts the variation Y to/from the rate X, calculating a rental C, and calculates the charge G for the use of the vehicle by multiplying the rental C by the period of use T in the same conditions.

In a preferred embodiment, the means 14 for detecting the number of individuals on board detect and make available to the data-processor 7 data relating to the number N of individuals on board. The user of the boat and the guests wear bracelets with transponders, enabling the means 14 to detect the presence of the bracelets on board the boat and to determine the number of individuals, by known methods. In the example described, the number of individuals is greater than two.

The data-processor 7 acquires from the tariff-fixing device 6 a variation factor F′″ to be applied to the reference hourly rate X owing to the presence of a number of individuals greater than two on board the boat.

The data-processor 7 calculates a variation Y of the rate X by multiplying the reference hourly rate-X by the total factor AT which is the sum of the factor F′ due to the stay in harbour, of the factor F″ due to the use of a motor boat of known brand, and of the variation factor F′″ due to the presence of a number of individuals greater than two on board, adds/subtracts the variation Y to/from the rate X, calculating the rental C, and calculates the charge G for the use of the vehicle by multiplying the rental C by the period of use T in the same conditions, expressed in hours.

Moreover, the tax-evaluation means 20 can evaluate a tax amount and make it available to the data-processor 7. In the example described, the harbour is in national waters. The locating device 3 makes the location of the boat available to the tax-evaluation means 20.

The tax-evaluation means 20 acquires the data relating to the current position P from the locating device 3, compares it with the chart data M made available by the chart control device 18, detects that the boat is in national waters, and makes the datum relating to the presence of the boat in national waters available to the data-processor 7.

The data-processor 7 acquires from the tariff-fixing device 6 a factor I′, corresponding to the value-added tax factor, for the variation of the rental C owing to the presence of the boat in national waters.

The data-processor 7 calculates the variation Y of the reference hourly rate X by multiplying the reference hourly rate X by the total factor AT which is the sum of the factor F′ due to the stay in port, of the factor F″ due to the use of a boat with an engine of known brand, and of the variation factor F′ due to the presence of a number of individuals greater than two on board, adds/subtracts the variation Y to/from the reference rate X, calculating the rental C, calculates the tax I by multiplying the rental C by the tax factor I′, calculates a new rental C′ by adding the tax I to the rental C, and calculates the charge G for the use of the vehicle by multiplying the new rental C′ by the period of use T in the same conditions, expressed in hours.

The user-identification means 13 can also evaluate and make available to the data-processor 7 the data relating to the user's identity U.

In a preferred example of use, the user inserts his smart card in the appropriate reader at the beginning of the period of use of the vehicle or craft. The smart card contains user-identity data U such as registration data, the type of licence or navigation certificate, the number of years for which the licence or certificate has been held, and the like. The smart-card reader is operatively connected to the data-processor 7 which acquires the data relating to the user's identity U.

If, for example, the user has an age of between thirty-five and forty-five years, the data-processor 7 acquires from the tariff-fixing device 6 a variation factor F^{IV} to be applied to the reference hourly rate X due to the user's age.

The data-processor 7 calculates the variation Y of the reference rate X by multiplying the rate X by the total factor AT which is the algebraic sum of the factor F′ due to the stay in harbour, of the factor F″ due to the use of a boat with an engine of known brand, of the variation factor F′″ due to the presence of a number of individuals greater than two on board, and of the variation factor F^{IV} due to the user's age, adds/subtracts the variation Y to/from the reference rate X, calculating the rental C, calculates a tax I by multiplying the rental by the tax factor I′, calculates a new rental C′ by adding the tax I and the rental C, and calculates the charge G for the use of the vehicle by multiplying the new rental C′ by the period of use T in the same conditions, expressed in hours.

The risk-evaluating means 21 can also evaluate and make available to the data-processor 7 data relating to the presence of a risk, such as navigation or driving in busy areas, the use of the vehicle or craft by an inexperienced user, or use at high speeds or with rapid acceleration.

If, for example, the user of the boat has held a navigation certificate for less than ten years and the boat is stationary in a harbour, the location device 3 operatively connected to the risk-evaluation means 21 makes available the data relating to the current position P of the boat. The risk-evaluation means 21 acquires the chart data M from the chart control device 18 and compares the current position P with the chart data M, detecting the presence of the boat in harbour and sending to the data-processor 7 a signal indicative of the absence of risk due to navigation in busy areas. Similarly, the data-processor 7 acquires the data relating to the user identification U from the user-identification means 13 and compares the data U with the data stored in a database included in the means 21 in order to evaluate the risk connected with the use of a boat by an inexperienced user.

The data-processor 7 acquires from the tariff-fixing device 6 a variation factor F^{V} to be applied to the reference hourly rate X due to the absence of risk due to navigation in busy areas and a variation factor V^{VI} to be applied the reference hourly rate X due to the presence of risk owing to the use of the boat by an inexperienced user.

The data-processor 7 calculates a variation Y of the reference rate x by multiplying the reference rate X by a total factor AT, also calculated on the basis of the factors due to the risk evaluation, calculates a rental C on the basis of the variation Y of the reference rate X, acquires the tax I, calculates a new rental C′ on the basis of the tax I and of the rental C and calculates the charge G for the use of the vehicle on the basis of the period T of use of the vehicle in the same conditions.

The charge G for the use of the vehicle is evaluated continuously over time, from the date on which the hire or charter agreement is entered into to the date on which the agreement terminates. The charges evaluated over time are accumulated and determine the total charge K due from the user to the provider for the use of the vehicle or craft for the entire hire period.

By way of numerical example, the charge G for the use of the craft, in the case of a boat, may be evaluated in accordance with the following situation: the boat subject to the charter agreement is a motor boat, chartered to a user who is thirty-six years old and who has held a navigation certificate for 8 years. For a period of time of 3 hours duration, the boat is left stationary in harbour whilst three individuals, in addition to the hirer, are present on board.

The table given in FIG. 4 is taken as an example of a tariff.

The reference hourly rate X agreed between the provider and the user is Lire 9722.

When the user takes possession of the boat, he inserts his smart card in the smart-card reader and makes the user-identification data U available to the data-processor 7. The data-processor 7 acquires from the tariff-fixing device 6 the variation factor to be applied the reference hourly rate X due to the user having an age of between thirty-five and forty-five years, which factor is equal to 0.25%.

The risk-evaluating means 21 acquire the user-identification data U and indicate to the data-processor 7 the presence of a risk due to the use of the boat by an inexperienced user and the absence of risk due to the boat remaining in harbour.

The data-processor 7 acquires from the tariff-fixing device 6 a variation factor to be applied to the reference hourly rate X due to the risk for an inexperienced user, which factor is equal to 0.20%, and a variation factor to be applied to the reference hourly rate X due to the absence of risk owing to the boat remaining in harbour, which factor is equal to 0.50%.

Moreover, the tax-evaluation means 20, typically a computer, acquires data relating to the current position P of the boat from the locating device 3, compares it with the position on a chart made available by the chart control device 18, detects that the boat is in national waters, and makes the datum relating to presence in national waters available to the data-processor 7. The data-processor 7 acquires from the tariff-fixing device 6 a tax factor, equal to 20%, due to the presence of the boat in national waters.

The means 14 for detecting the number of individuals detect the presence of four people on board by means of a bracelet transponder system, and communicate the respective datum to the data-processor 7. The data-processor 7 acquires from the tariff-fixing device 6 a variation factor to be applied to the reference hourly rate X owing to the presence of more than two people on board, which factor is equal to 0.25%.

The data-processor 7 adds up the factors acquired, obtaining a total factor equal to −0.3% (−0.25+0.20−0.50+0.25=−0.3), calculates the variation Y of the rate X, which is equal to −0.3% of 9722, that is, about Lire 29 (9722*0.3/100=29), subtracts the variation Y from the rate X, obtaining the rental C, which is equal to 9693 Lire (9722−29=9693). By multiplying the rental C by the factor due to tax, which is equal to 20%, the data-processor 7 calculates the tax I, which is equal to 1939 Lire (9693*20/100=1939). By adding together the tax I and the rental C, the data-processor 7 calculates a new rental C′ equal to Lire 11631 (9722+1939=11631). Finally, the data-processor 7 calculates the hire charge G by multiplying the new rental C′ by the period of use of the vehicle in these conditions, which is equal to three hours. The charge G calculated is 34893 Lire (11631*3=34893).

The charge G is transmitted to the centre and stored by the charge storage device 19. The charges calculated at successive times are accumulated and credited/debited to a current account indicated by the user by a credit card loop.

Naturally, in order to satisfy contingent and specific requirements, a person skilled in the art may apply to the above-described apparatus many modifications and variations all of which, however, are included within the scope of protection of the invention as defined by the appended claims.

What is claimed is:

1. Apparatus for evaluating a charge for the use of a vehicle or craft, the apparatus comprising:
a locating device provided on board the vehicle or craft, for determining and making available continuously over time, data relating to the current position of the vehicle or craft,
a timing device provided on board the vehicle or craft for determining and making available data relating to the period of use of the vehicle or craft,
a tariff-fixing device for determining and making available data relating to predefined rates, on the basis of a tariff,
a data-processor provided on board the vehicle or craft and operatively connected to the locating device, to the timing device and to the tariff-fixing device, the data-processor being able to calculate a charge for the use of the vehicle on the basis of the data relating to the current position of the vehicle or craft, of the data relating to the period of use of the vehicle or craft, of the tariff data.

2. Apparatus for evaluating a charge for the use of a vehicle or craft according to claim 1, further comprising risk-evaluating devices for providing data relating to the presence of risk, in which the data-processor is further operatively connected to the risk-evaluating devices to calculate a charge for the use of the vehicle on the basis of the data relating to the current position of the vehicle or craft, of the data relating to the period of use of the vehicle or craft, of the tariff data and of the data relating to the presence of risk.

3. Apparatus according to claim 2, provided with means for identifying the vehicle or craft, the means being provided on board the vehicle or craft, operatively connected to the data-processor, and capable of making available to the data-processor data relating to the vehicle used, in order for the charge for the use of the vehicle or craft to be evaluated on the basis of the vehicle or craft used.

4. Apparatus according to claim 3 in which the means for identifying the vehicle or craft comprises a device for storing data relating to the vehicle or craft used, such as the vehicle registration number.

5. Apparatus according to claim 1, provided with means for identifying the user, the means being provided on board the vehicle or craft, operatively connected to the data-processor, and capable of making available to the data-processor data relating to the user's identity, in order for the charge for the use of the vehicle or craft to be evaluated on the basis of the identity of the user of the vehicle or craft.

6. Apparatus according to claim 5 in which the means for identifying the user can cooperate with a card provided with an integrated circuit (a smart card) on which data relating to the user's identity is stored.

7. Apparatus according to claim 6 in which the means for identifying the user comprises a smart-card reader.

8. Apparatus according to claim 5 in which the means for identifying the user comprises a keyboard for the keying-in of data relating to the user's identity.

9. Apparatus according to claim 1, provided with means for detecting the presence of individuals on board the vehicle or craft, the means being operatively connected to the data-processor and capable of making available to the data-processor data relating to the number of individuals on board the vehicle or craft, in order for the charge for the use of the vehicle or craft to be evaluated on the basis of the number of individuals on board the vehicle or craft.

10. Apparatus according to claim 9 in which the means for detecting the presence of individuals on board the vehicle or craft comprise conventional bracelet transponders.

11. Apparatus according to claim 1, comprising means for detecting the speed of the vehicle or craft, the means being provided on board the vehicle or craft, operatively connected to the data-processor, and capable of making available to the data-processor data relating to the current speed of the vehicle or craft, in order for the charge for the use of the vehicle to be evaluated on the basis of the current speed of the vehicle or craft.

12. Apparatus according to claim 11 in which the speed-detecting means comprise a tachometer.

13. Apparatus according to claim 11 in which the speed-detecting means comprise a log (a device for measuring the speed of a vessel).

14. Apparatus according to claim 1, comprising means for detecting the acceleration of the vehicle or craft, the acceleration-detecting means being provided on board the vehicle or craft, operatively connected to the data-processor, and capable of making available to the data-processor data relating to the current acceleration of the vehicle or craft, in order for the charge for the use of the vehicle or craft to be evaluated on the basis of the current acceleration of the vehicle or craft.

15. Apparatus according to claim 1 in which the position-locating device comprises a conventional global positioning system.

16. Apparatus according to claim 1 in which the position-locating device comprises a conventional “Standard C” system.

17. Apparatus according to claim 1, comprising a sensor for detecting the activation of the propulsion unit of the vehicle, for evaluating the condition of use of the vehicle or craft, that is, whether it is moving, stationary, or not in use.

18. Apparatus according to claim 17 in which the activation sensor comprises a position transducer associated with a transmission member of the propulsion unit of the vehicle or craft.

19. Apparatus according to claim 1, provided with a visual indicator device disposed on board the vehicle or craft, operatively connected to the data-processor, and capable of displaying the charge for the use of the vehicle or craft.

20. Apparatus according to claim 19 in which the visual indicator device is a conventional display.

21. Apparatus according to claim 1, comprising a data-transmission device provided on board the vehicle or craft, and a data-receiving device provided in a processing centre, the devices being and arranged, respectively, for transmitting and for receiving the data relating to the charge for the use of the vehicle or craft.

22. Apparatus according to claim 21 in which the data-transmission device can transmit to the processing centre further data relating to the current position of the vehicle or craft, to the period of use, to the vehicle or craft used, to the user's identity, to the number of individuals on board the vehicle or craft, to the current speed of the vehicle or craft, and to the current acceleration of the vehicle or craft.

23. Apparatus according to claim 22 in which the data-transmission device comprises radio-wave transmission means.

24. Apparatus according to claim 23 in which the radio-wave transmission means comprise a conventional GSM system.

25. Apparatus according to claim 1, provided with a device for controlling maps or charts, operatively connected at least to the data-processor, and capable of storing maps or charts and for making data relating to the maps or charts available to the data-processor.

26. Apparatus according to claim 1, provided with a device, operatively connected to the data-processor, for storing the charge for the use of the vehicle or craft.

27. Apparatus according to claim 1, provided with means for evaluating a tax, the means being operatively connected at least to the device for locating the vehicle or craft, to the map or chart control device, and to the data-processor, and being capable of making an tax amount available to the data-processor.

28. Apparatus according to claim 1, provided with risk-evaluation means operatively connected at least to the data-processor, to the vehicle-locating device, and to the map or chart control device.

29. Apparatus according to claim 28 in which the risk-evaluation means are operatively connected at least to one of the means for identifying the vehicle or craft, the user-identification means, the means for detecting the presence of individuals on board, the speed-detecting device, and the acceleration-detecting device.

30. A method of evaluating a charge for the use of a vehicle or craft, which provides for the following steps:
evaluating the current position of the vehicle or craft,
evaluating the period of use of the vehicle or craft,
evaluating a rate from a tariff,
evaluating a charge for the use of the vehicle or craft on the basis of the evaluations of the current position of the vehicle or craft, of the period of use of the vehicle or craft, and of the rate.

31. A method of evaluating a charge for the use of a vehicle or craft according to claim 30, further comprising the step of
evaluating a risk, and
evaluating a charge for the use of the vehicle or craft on the basis of the evaluations of the current position of the vehicle or craft, of the period of use of the vehicle or craft, of the rate and of the risk.

32. A method according to claim 31 in which the vehicle or craft used is evaluated and the charge for the use of the vehicle or craft is determined on the basis of the vehicle or craft used.

33. A method according to claim 32 in which the user's identity is evaluated and the charge for the use of the vehicle or craft is determined on the basis of the user's identity.

34. A method according to claim 30 in which the number of people on board the vehicle or craft is evaluated and a charge for the use of the vehicle or craft is determined on the basis of the number of people on board the vehicle or craft.

35. A method according to claim 30 in which the current speed of the vehicle or craft is evaluated and the charge is determined on the basis of the speed of the vehicle or craft.

36. A method according to claim 30 in which the acceleration of the vehicle craft is evaluated and a charge is determined on the basis of the acceleration of the vehicle or craft.

37. A method according to claim 30 in which a tax is evaluated and a charge is determined on the basis of the tax.

38. A method according to claim 30 in which a risk factor is evaluated on the basis of the current position of the vehicle or craft, of data identifying the vehicle or craft, of the user-identification data, and of the speed and acceleration data, and a charge is determined on the basis of the risk factor.
